(19) United States
(12) Patent Application Publication
(10) Pub. No.: US 2007/0077498 A1
(43) Pub. Date: Apr. 5, 2007

(54) Optical recording composition, optical recording medium and production method thereof, optical recording method and optical recording apparatus

(75) Inventors: Masatoshi Yumoto, Shizuoka (JP); Takekatsu Sugiyama, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/528,378

(22) Filed: Sep. 28, 2006

(30) Foreign Application Priority Data
Sep. 30, 2005 (JP) 2005-289321

(51) Int. Cl. G03H 1/04; G03C 1/00

(52) U.S. Cl. 430/1; 430/2; 359/3; 430/281.1

(57) ABSTRACT

Provided are optical recording compositions that bring about optical recording media capable of multiple-recording interference images formed by an informing light and a reference light with higher sensitivity, the methods for producing the same, and optical recording methods and optical recording apparatuses that utilize the optical recording media. The optical recording compositions comprise a binder and a polymerizable monomer, wherein the binder has a site to initiate a photopolymerization reaction.

### BACKGROUND OF THE INVENTION

1. Field of the Invention

The present invention relates to optical recording compositions, utilized for optical recording media to record information by use of holography, that can provide the optical recording media with higher sensitivity and superior multiple recording; the optical recording media and production method thereof; optical recording methods and optical recording apparatuses that utilize the optical recording media.

2. Description of the Related Art

One type of recording media capable of recording large amounts of information e.g. high-density image data is optical recording media. The optical recording media have been commercially introduced, for example, in a form of rewritable optical recording media such as optical magnetic discs and phase change optical discs and in a form of recordable optical recording media such as CD-Rs. These optical recording media have been limitlessly demanded for their still larger capacity. However, all of optical recording media have conventionally been based on two-dimensional record, which forces a limit in a sense for increasing their recording capacity. Accordingly, optical recording media of hologram type are attracting attention in recent years that are capable of recording in three-dimensional fashion.

The optical recording media of hologram type typically record information in a way that an informing light having a two-dimensional intensity distribution and a reference light having approximately the same intensity with the reference light are duplicated at inside of a photosensitive recording layer, thereby causing a distribution of optical properties. On the other hand, when recorded information is to be read or reproduced, only the reference light is irradiated onto the recording layer in the similar arrangement as at the recording, and the reproducing light having the intensity distribution corresponding to the optical property distribution formed inside the recording layer is caused to emit from the recording layer.

In the optical recording media of hologram type, the optical property distribution is three-dimensionally formed inside the recording layer, therefore, one region where information being recorded by an informing light and another region where information being recorded by another informing light can be partially overlapped, thus multiple recording can be realized. When digital volume holography is available, the original information can be reproduced exactly even if the overwriting lowers somewhat the signal/noise ratio (S/N ratio) by virtue that the S/N ratio can be made remarkably higher at one spot. As a result, the multiple recording times can be extended into as long as several hundred times, and the recording capacity of optical recording media can be increased remarkably (see Japanese Patent Application Laid-Open (JP-A) No. 2002-123949).

An optical recording composition, utilized for such hologram-type optical recording media, is proposed that comprises for example a radical polymerizable monomer, a binder polymer, a radical photopolymerization initiator and a sensitizing dye, and makes use of the difference of refractive indices between the radical polymerizable monomer and the binder polymer (see JP-A No. 06-43634). When the optical recording composition is shaped into a film and exposed to an interference light, radical polymerization occurs at sites where being exposed intensively, then the radical polymerizable monomer represents a concentration gradient and a diffusion migration from sites being less exposed to sites being intensively exposed. Consequently, there appear dense and dilute sites of the radical polymerizable monomer depending on the intensity of the interference light, which provides the sites with different refractive indices.

Another example of optical recording compositions for volume-type hologram relates to an optical recording composition that contains a polymer matrix precursor containing an NCO-ended prepolymer and a polyol, a bifunctional epoxide and a tetrafunctional mercaptan, or the like. The polymer matrix precursor is disposed between two base materials in a predetermined thickness, then the precursor is reacted into a polymer matrix, thereby a hologram-type recording medium is produced with no use of coating solvent (see U.S. Pat. No. 6,482,551). Hologram recording may be achieved by exposing the resulting recording medium of hologram-type to interference lights.

There exists a beneficial feature in the hologram recording that two times or more of writings can be carried out at each of recording spots by way of changing the incident angle, incident site, wavelength etc. of coherent lights such as laser beams.

However, there also exists a problem in the optical recording media of hologram-type that the resultant interference images are likely to become unsatisfactory and the writing multiplicity degrades, when the sites of polymer, prepared by photopolymerization reaction at inside of recording layers, are changed every times while interference images are being recorded by use of photopolymerization reaction induced by optical property distribution and hologram recording is being carried out with higher multiplicity.

Accordingly, optical recording compositions that result in optical recording media capable of multiple-recording with higher sensitivity, and hologram-type optical recording media capable of multiple-recording with higher sensitivity by use of an informing light and a reference light have not been attained yet, thus the prompt development thereof have been desired.

### SUMMARY OF THE INVENTION

The present invention purposes to solve the problems described above and to attain the following objects. It is an object of the present invention to provide optical recording compositions that bring about optical recording media capable of multiple-recording with higher sensitivity; another object of the present invention is to provide hologram-type optical recording media capable of multiple-recording with higher sensitivity by use of an informing light and a reference light; another object of the present invention is to provide methods for producing the hologram-type optical recording media; still other objects are to provide optical recording methods and optical recording apparatuses that utilize the optical recording media.

The optical recording composition according to the present invention comprises a binder and a polymerizable monomer, wherein the binder has a site to initiate a photopolymerization reaction. Since the inventive optical recording composition comprises a binder with a site to initiate a photopolymerization reaction and a polymerizable monomer, the polymer yielded by the polymerization is less diffusive and the resultant interference stripes are difficult to move, consequently the sensitivity and multiplicity can be enhanced.

The optical recording medium according to the present invention comprises a recording layer that contains the inventive optical recording composition described above. The optical recording medium according to the present invention is highly sensitive and adapted to multiple recording of interference images formed from an informing light and a reference light, since the inventive optical recording medium comprises a recording layer that contains the inventive optical recording composition.

The optical recording method according to the present invention comprises irradiating an informing light and a reference light having mutual coherence onto the inventive optical recording medium described above to form an interference image from the informing and the references light thereby to record the interference image on the optical recording medium.

The optical recording method according to the present invention is highly sensitive and adapted to multiple recording of interference images formed from an informing light and a reference light, since the inventive optical recording method makes use of the inventive optical recording medium.

The optical recording apparatus according to the present invention comprises an image forming unit configured to form an interference image by irradiating an informing light and a reference light having mutual coherence onto the inventive optical recording medium, and a recording unit configured to record the interference image on the optical recording medium.

The optical recording apparatus according to the present invention is highly sensitive and adapted to multiple recording of interference images formed from an informing light and a reference light, since the inventive optical recording apparatus makes use of the inventive optical recording medium.

### BRIEF DESCRIPTION OF THE DRAWINGS

FIG. 1 is a partial cross section of an optical recording medium.

FIG. 2 is a partial cross section of an optical recording medium of disc-type.

FIG. 3 is an exemplary schematic cross section of an optical recording medium.

FIG. 4 is an exemplary schematic cross section that shows an optical recording medium in an embodiment of the present invention.

FIG. 5 is an explanatory view that shows exemplarily an optical system around an optical recording medium.

FIG. 6 is a block diagram that shows exemplarily an entire construction of an optical recording and reproducing apparatus of the second embodiment according to the present invention.

### DESCRIPTION OF THE PREFERRED EMBODIMENTS

Optical Recording Composition

The optical recording composition according to the present invention comprises a binder that has a site to initiate a photopolymerization reaction, a polymerizable monomer, and optional other ingredients.

The term “optical recording” as used herein means optical recordings by use of multiple recordings. The optical recording may be applied to non-multiple recording e.g. mono-recording.

Binder Having Site of Photopolymerization Reaction

The binders, having a site to initiate a photopolymerization reaction, may be present in a manner that a photopolymerization initiator attaches to at least a part of polymerizable monomer that constitutes the binder. The site to initiate a photopolymerization reaction may be involved into the binder at the stage prior to initiating the photopolymerization reaction.

The binder having a site to initiate a photopolymerization reaction may be a product obtained by reacting a binder or a binder precursor with a photopolymerization initiator. In the hologram recording media of hologram type, recording is carried out on the basis of the sites of polymers derived from polymerizable monomers, therefore, the recording disappears when the polymers migrate due to diffusion. The photopolymerization of polymerizable monomers typically initiate by action of decomposed products starting from the photodecomposition of photopolymerization initiators, therefore, polymers generated from polymerizable monomers are more likely to bond to the binder in cases where the photopolymerization initiators are fixed by the binders compared to the cases where the photopolymerization initiators are free from the binders. Accordingly, photopolymerization initiators fixed to binders can bring about more proper recording.

The binder having a site to initiate a photopolymerization reaction may be synthesized, for example, by reaction between a photopolymerization initiator and a binder, reaction between a photopolymerization initiator and a polymerizable monomer of binder, or reaction between a photopolymerization initiator and a polymerizable monomer of binder followed by polymerization reaction of the resulting product. These reactions may be carried out along with the preparation of the optical recording composition, alternatively the binder having a site to initiate a photopolymerization reaction may be synthesized preliminarily and added to the optical recording composition.

The bond between the binder or the polymerizable monomer of the binder and the photopolymerization initiator is not necessary to be limited definitely, for example, may be a covalent bond or an ionic bond. Among these, the covalent bond is preferable in view of chemical stability.

The binder having a site to initiate a photopolymerization reaction tends to exhibit less diffusivity of the resultant polymer compared to the binder having no such site since the site to initiate a photopolymerization reaction may be fixed in the optical recording composition; therefore, the sensitivity and multiplicity may be enhanced due to less mobility of the resultant interference stripes.

It is preferred that content of the site to initiate a photopolymerization reaction is 5% by mass to 50% by mass based on the binder, more preferably 10% by mass to 40% by mass. In cases where the content is less than 5% by mass, the sensitivity and multiplicity may be insufficient due to insufficient polymerization of the polymerizable monomer; and in cases where the content is more than 50% by mass, the polymerization of the polymerizable monomer may also be insufficient due to higher possibilities of recombination between decomposed photopolymerization initiators, which possibly leading to insufficient sensitivity and multiplicity.

Binder

The binder may effectively enhance the coating ability, film strength, difference of refractive indices, and sensitivity.

The binder may be properly selected depending on the application; examples thereof include copolymers of unsaturated acids such as (meth)acrylic acid or itaconic acid and alkyl(meth)acrylate, phenyl(meth)acrylate, benzyl(meth)acrylate, styrene or alpha-methylstyrene; polymers of alkylmethacrylate or alkylacrylate such as polymethylmethacrylate; copolymers of alkyl(meth)acrylate and acrylonitrile, vinyl chloride, vinylidene chloride, styrene or the like; copolymers of acrylonitrile and vinyl chloride or vinylidene chloride; modified celluloses having a carboxyl group at side chains; polyethylene oxide; polyvinyl pyrrolidone; novolac resins obtained by condensation reaction of phenol, o-, m- or p-cresol and/or xylenol and aldehyde, acetone; polyethers of epichlorohydrin and bisphenol A; soluble nylon, polyvinylidene chloride; chlorinated polyolefins; copolymers of vinyl chloride and vinyl acetate; polymers of vinyl acetate; copolymers of acrylonitrile and styrene; copolymers of acrylonitrile, butadiene and styrene; polyvinyl alkylethers; polyvinyl alkylketones; polystyrenes; polyurethanes; polyethylene terephthalateisophthalate; acetylcelluloses; acetylpropyoxycelluloses; acetylbutoxycelluloses; nitrocelluloses; celluloid; polyvinyl butyral; epoxy resins; melamine resins; formaldehyde resins; polyurethane resins of polyvalent alcohols and polyvalent isocyanates; polyurethanes formed from polyvalent alcohols, water and polyvalent isocyanates/urea resins; and organic siloxane polymers. Among these, preferable are polymers of alkylmethacrylate or alkylacrylate; epoxy resins; polyurethane resins of polyvalent alcohols and polyvalent isocyanates; polyurethanes formed from polyvalent alcohols, water and polyvalent isocyanates/urea resins; and organic siloxane polymers. These may be used alone or in combination. The term “(meth)acryl” as used herein means one or both of “acryl” and “methacryl”.

Specific examples of the binder may be those containing biscyclohexyl methanediisocyanate, polypropyleneoxide triol and tetramethylene glycol.

The content of the binder is preferably 20 parts by mass to 97 parts by mass on the base of solid content in the optical recording composition, more preferably 50 parts by mass to 95 parts by mass.

Site to Initiate Photopolymerization Reaction

The site to initiate a photopolymerization reaction may be properly selected as long as being sensitive to recording lights and capable of inducing a radical polymerization reaction upon optical irradiation; examples of the site include 2-trichloromethyl-1,3,4-oxadiazole skeleton, 2,4-bis(trichloromethyl)-1,3,5-triazine skeleton, alpha-hydroxyacetophenone skeleton, benzylketal skeleton, acylphosphineoxide skeleton, triarylalkylborate tetraalkylammonium skeleton, bisimidazole skeleton, titanocene skeleton, oxime skeleton and benzylketal skeleton. Among these, 2-trichloromethyl-1,3,4-oxadiazole skeleton, 2,4-bis(trichloromethyl)-1,3,5-triazine skeleton, bisimidazole skeleton, titanocene skeleton, oxime skeleton and benzylketal skeleton are preferable in view of higher purity.

Binders having a site to initiate a photopolymerization reaction can be synthesized, for example, by introducing a functional group into a part of the substituent of the site that interacts with the binder or the monomer of the binder.

The functional group may be, for example, halogen atoms, hydroxyl group, carboxyl group, amino group, ammonio group, diazonio group, sulfonic acid group and nitrogen-containing heterocyclic groups. In addition, the site to initiate a photopolymerization reaction may be prepared from compounds having the functional groups or precursors of the functional groups. The photopolymerization initiators of compounds having the site to initiate a photopolymerization reaction may be used alone or in combination.

Specific examples of the photopolymerization initiators may be the specific compounds of Nos. 1 to 16 shown below.

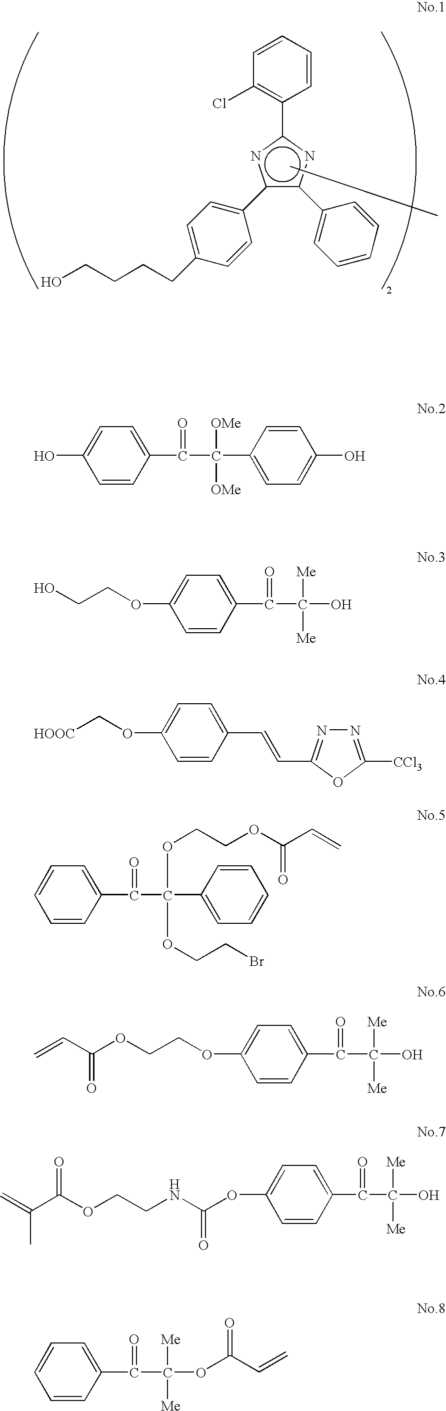

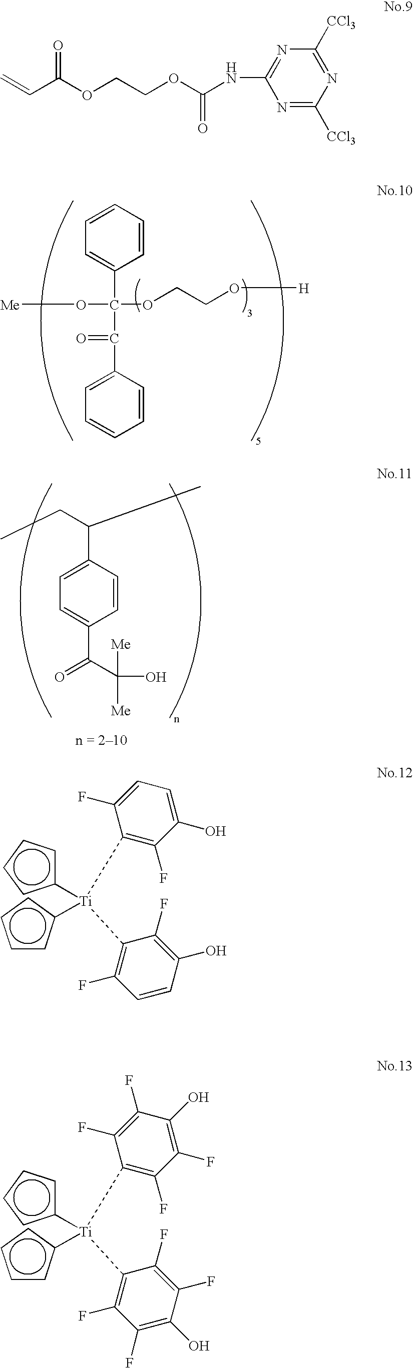

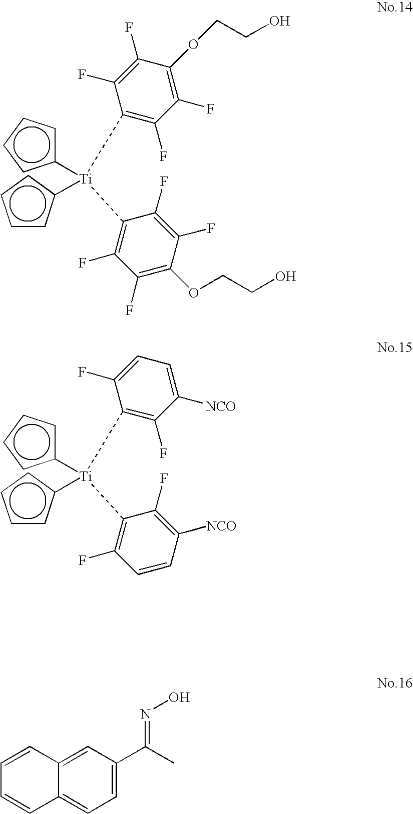

The reaction between the photopolymerization initiator and the binder or the monomer of the binder may be, for example, urethanizing reaction, esterifying reaction, amidizing reaction, etherizing reaction, N-alkylating reaction, quaternary-ammonifying reaction or azocoupling reaction.

When an ionic bond is utilized in the reaction between the photopolymerization initiator and the binder or the monomer of the binder, it is preferred that such reactions are utilized as of between carboxyl group and amino group or nitrogen-containing heterocyclic group, sulfonic acid group and amino group or nitrogen-containing heterocyclic group, or ammonio group and carboxylate or sulfonate.

When the site to initiate a photopolymerization reaction is introduced into a polymerizable monomer of the binder, the polymerization of the polymerizable monomer may form the binder.

The polymerization reaction of the polymerizable monomer may be, for example, vinyl polymerization of ethylenically unsaturated monomers, cationic ring-opening polymerization of epoxy or oxetane rings, polycondensation reaction between epoxies and mercaptans or amines, polycondensation reaction between alcohols and isocyanates, or polycondensation reaction between alcohols and carboxylic acid derivatives. Catalysts may be employed into these reactions; tin catalysts, nitrogen-containing heterocyclic groups, amines or the like may be employed, for example, as a catalyst into the polycondensation reaction between alcohols and isocyanates.

Specific examples of the tin catalyst are dimethyltindilaurate, dibutyltindilactate and tin octanoate. Specific examples of the nitrogen-containing heterocyclic group are imidazole, pyridine and pyrazole. Specific examples of the amine are triethylamine, trioctylamine and N-methylmorpholine.

The content of the photopolymerization initiator, which reacts with the binder precursor or the monomer of the binder, is preferably 0.3% by mass to 6% by mass based on the entire solid content of the optical recording composition, more preferably 0.5% by mass to 3% by mass.

It is preferred that the binder having a site to initiate a photopolymerization reaction forms a three-dimensional crosslinked body. The molecular weight of the binder is preferably no less than 1500, more preferably no less than 3000 in cases where the binder is a linear polymer.

The optical recording composition according to the present invention may additionally contain a binder or a monomer of binder having no site to initiate a photopolymerization reaction, or may additionally contain a photopolymerization initiator non-bonding to the binder prior to initiating the photopolymerization reaction.

The content of the photopolymerization initiator no bonding to the binder is preferably no more than 0.5% by mass based on solid content of the optical recording composition, more preferably no more than 0.1% by mass.

Furthermore, sensitizing dyes may be additionally included into the optical recording composition as a sensitizer considering the wavelength of irradiating light.

The sensitizing dyes may be conventional compounds described in “Research Disclosure, vol. 200, December 1980, Item 20036” or “Sensitizer, pp. 160-163, Kodansha Ltd., ed. Katsumi Tokumaru and Shin Ohgawara, 1987”.

Specific examples of the sensitizing agents are 3-ketocoumarin compounds described in JP-A No. 58-15603; thiopyrylium salts described in JP-A No. 58-40302; naphthothiazole merocyanine compounds described in Japanese Patent Application Publication (JP-B) Nos. 59-28328 and 60-53300; and merocyanine compounds described in JP-B Nos. 61-9621 and 62-3842, JP-A Nos. 59-89303 and 60-60104.

Furthermore, the sensitizing agents may be the dyes described in “Functional Dye Chemistry, 1981, CMC Publishing Co., pp. 393-416” or “Color Material, 60 (4), pp. 212-224 (1987)”; more specific examples are cationic methine dyes, cationic carbonium dyes, cationic quinonimine dyes, cationic indoline dyes and cationic styryl dyes.

Still furthermore, the sensitizing agents may keto dyes such as coumarin dyes including ketocoumarin and sulfocoumarin, merostyryl dyes, oxonol dyes and hemioxonol dyes; non-keto dyes such as non-keto polymethine dyes, triarylmethane dyes, xanthen dyes, anthracene dyes, rhodamine dyes, acridine dyes, aniline dyes and azo dyes; non-keto polymethine dyes such as azomethine dyes, cyanine dyes, carbocyanine dyes, dicarbocyanine dyes, tricarbocyanine dyes, hemicyanine dyes and styryl dyes; and quinonimine dyes such as azine dyes, oxazin dyes, thiazin dyes, quinoline dyes and thiazole dyes. The sensitizing agents may be used alone or in combination of two or more.

The content of the sensitizing dyes is preferably 0.3% by mass to 6% by mass based on the total solid content in the composition for optical recording media, more preferably 0.5% by mass to 3% by mass.

Analysis of Binder

The analysis method of the binder having a site to initiate a photopolymerization reaction may be properly selected depending on the application; for example, the analysis method may be mass spectrometry on the basis of various gas chromatography techniques, mass spectrometry on the basis of liquid chromatography techniques, mass spectrometry on the basis of gel-permission chromatography techniques, Fourier transform IR spectrometry, microscopic Raman spectrometry, organic elemental micro analysis (C, H, N), microscopic IR spectrometry, nuclear magnetic resonance spectrum, gas chromatography, UltraViolet-Visual spectrometry and the like. The analysis method may also be carried out after decomposing the binder having a site to initiate a photopolymerization reaction by way of hydrolysis. Preferably, the analysis is carried out by gel-permission chromatography as well as UltraViolet-Visual spectrometry.

Polymerizable Monomer

The polymerizable monomer may be properly selected depending on the application; for example, the polymerizable monomer may be radical polymerizable monomers having an unsaturated bond such as acrylic group and methacrylic group or cationic polymerizable monomers having an ether structure such as epoxy ring and oxetane ring. These monomers may be monofunctional or polyfunctional. Optical crosslinking reaction may also be utilized for the polymerization.

Examples of the radical polymerizable monomers include acryloyl morpholine, phenoxyethylacrylate, isobornylacrylate, 2-hydroxypropylacrylate, 2-ethylhexylacrylate, 1,6-hexanediol diacrylate, tripropyleneglycol diacrylate, neopentylglycol PO modified diacrylate, 1,9-nonandiol diacrylate, hydroxylpivalic acid neopentylglycoldiacrylate, EO modified bisphenol A diacrylate, polyethyleneglycol diacrylate, pentaerythritol triacrylate, pentaerythritol tetraacrylate, pentaerythritol hexaacrylate, EO modified glycerol triacrylate, trimethylolpropane triacrylate, EO modified trimethylolpropane triacrylate, 2-naphtho-1-oxyethylacrylate, 2-carbazoyl-9-ylethylacrylate, (trimethylsilyloxy)dimethylsilyl propylacrylate, vinyl-1-naphthoate, N-vinylcarbazol, 2,4,6-tribromophenylacrylate, pentabromophenylacrylate, phenylthioethylacrylate and tetrahydrofurfurylacrylate.

Examples of the cationic polymerization monomers include bisphenol A epoxy resins, phenolnovolac epoxy resins, glycerol triglycidylether, 1,6-hexaneglycidylether, vinyltrimethoxysilane, 4-vinylphenyl trimethoxysilane, gamma-methacryloxy propyltriethoxysilane and compounds expressed by the formulas (M1) to (M6) below. These may be used alone or in combination of two or more.

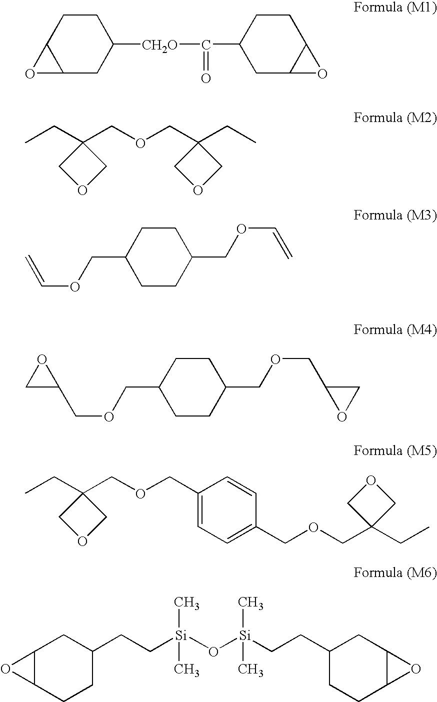

The content of the polymerizable monomer in the optical recording composition is preferably 3 parts by mass to 45 parts by mass based on the solid content in the optical recording composition, more preferably 4 parts by mass to 25 parts by mass.

Other Ingredients

The other ingredients described above may be properly selected depending on the application; for example, the other ingredients may be a polymerization inhibitor or antioxidant in order to improve storage stability or a photopolymerization initiator no bonding to the binder or the monomer of binder prior to the photopolymerization reaction.

The polymerization inhibitor or antioxidant may be properly selected depending on the application; examples thereof include hydroquinone, p-benzoquinone, hydroquinone monomethylether, 2,6-di-tert-butyl-p-cresol, 2,2′-methylenebis(4-methyl-6-tert-butylphenol), triphenylphosphite, trisnonyl phenylphosphite, phenothiazine and N-isopropyl-N′-phenyl-p-phenylene diamine. Among these, preferable are 2,6-di-tert-butyl-p-cresol and 2,2′-methylenebis(4-methyl-6-tert-butylphenol). These may be used alone or in combination.

The content of the polymerization inhibitor or antioxidant described above is preferably less than 3% by mass based on the monomer used in the composition. In cases where the content is more than 3% by mass, the polymerization tends to delay or cease in some cases.

The optical recording compositions may be added with photothermal conversion materials so as to enhance the sensitivity of the optical recording composition. The photothermal conversion materials are described in Japanese Patent Application No. 2005-84780, which is incorporated into by reference.

Furthermore, in order to reduce the volume change at polymerization, the optical recording compositions may be added with ingredients that can diffuse into the inverse direction with that of polymerizable ingredients, or compounds having an acid cleavage configuration may be added in addition to the polymers as required.

The photopolymerization initiator no bonding to the binder or the monomer of binder prior to the photopolymerization reaction may be properly selected depending on the application; examples thereof include 2,5-bis[(4-diethylamino-2-methylphenyl)methylene], p-methoxyphenyl-2,4-bis(trichloromethyl)-s-triazine, 2-(p-buthoxystyryl)-5-trichloromethyl-1,3,4-oxadiazole, 9-phenylacridine, 9,10-dimethylbenzphenazine, benzophenone/Michler's ketone, hexaarylbiimidazole/mercaptobenzoimidazole, benzyldimethylketal and thioxanthone/amine. These may be used alone or in combination of two or more.

The photopolymerization initiators may be commercially available; examples thereof include Irgacure 907, Irgacure 369, Irgacure 784 and Irgacure 814 (product name, by Ciba Specialty Chemicals); and Lucirin TPO (product name, by BASF Corp.). It is preferred the photopolymerization initiator is used along with a hydrogen-donating compound such as 2-mercaptobenzoxazole in some cases.

The optical recording compositions according to the present invention may also be prepared from the precursors of the optical recording compositions. The precursors of the optical recording compositions comprise a portion for forming the binder having a site to initiate a photopolymerization reaction and the polymerizable monomer, and optional other ingredients.

The aforesaid portion for forming the binder having a site to initiate a photopolymerization reaction may be the binder precursors, the photopolymerization initiators (containing the site to initiate a photopolymerization reaction), and the sensitizing dyes, for example.

These binder precursors, photopolymerization initiators and sensitizing dyes may be the binder precursors, photopolymerization initiators and sensitizing dyes discussed in terms of the optical recording compositions. The polymerizable monomers may be the polymerizable monomers discussed in terms of the optical recording compositions. The other ingredients may be the other ingredients discussed in terms of the optical recording composition. The optical recording compositions may be prepared by heat-treating the precursors of the optical recording compositions.

Optical Recording Medium, Method and Apparatus

The optical recording media according to the present invention comprise a recording layer for recording information on the basis of holography and optional other members.

The optical recording media according to the present invention may be of relatively thin plane holograms to record two-dimensional information or volume holograms to record numerous information such as stereo images or of transmissive or reflective type. The recording mode of the hologram may be, for example, of amplitude hologram, phase hologram, brazed hologram or complex amplitude hologram.

The inventive optical recording methods and apparatuses record and reproduce the inventive optical recording media.

The inventive optical recording methods and apparatuses may be applied to the conventional optical recording methods and apparatuses, for example, described in U.S. Pat. Nos. 5,719,691, 5,838,467, 6,163,391 and 6,414,296; U.S. Patent Application Publication No. 2002-136143; JP-A Nos. 2000-98862, 2000-298837, 2001-23169, 2002-83431, 2002-123949, 2002-123948, 2003-43904 and 2004-171611; WO 99/57719, WO02/05270 and WO02/75727.

The inventive optical recording media include a first embodiment in which the recording layer is laminated on a support and the optical recording media are applied to conventional hologram recording where an informing light and a reference light are irradiated from different directions, and a second embodiment in which the optical recording media are applied to Collinear systems in which an informing light and a reference light are irradiated in a manner that the optical axis of the informing light is coaxial with the optical axis of the reference light, and comprises a first substrate, a second substrate, and a recording layer on the second substrate. The first and the second embodiments will be explained successively in the following.

First Embodiment

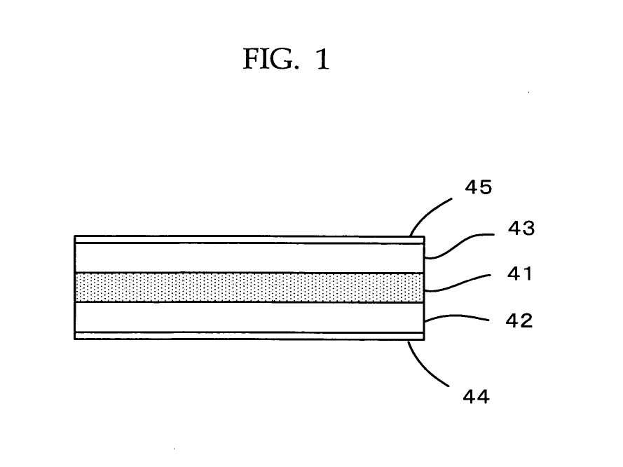

The first embodiment described above may be employed to conventional hologram recording methods; the layer construction may be properly selected depending on the purpose, for example, the layers are constructed such that the recording layer is laminated as mono-layer or two or more layers on the support; or as shown in FIG. 1, recording layer 41 is sandwiched between supports 42 and 43, and antireflective layers 44 and 45 are respectively arranged on supports 42 and 43 as the outermost layers.

Furthermore, a gas-barrier layer etc. may be formed between the recording layer 41 and support 42 or between the recording layer 41 and support 43; a protective layer may be provided on antireflective layers 44 and 45.

Informing Light and Reference Light

The informing light and the reference light may be properly selected depending on the purpose, preferably are a coherent laser light emitted from a light source.

The laser light may be properly selected depending on the purpose; for example, laser lights having one or more wavelengths within 360 nm to 850 nm are exemplified. The wavelength is preferably 380 nm to 800 nm, more preferably 400 nm to 750 nm, most preferably 500 nm to 600 nm which allows to visualize the center of visual region.

When the wavelength is less than 360 nm, clear stereo images may be difficult to obtain, and when more than 850 nm, the interference stripes come to excessively fine for usual photosensitive materials.

The source of the laser light may be properly selected depending on the purpose; examples thereof include solid laser oscillators, semiconductor laser oscillators for blue region, liquid laser oscillators, gas laser oscillators e.g. of argon, He—Cd liquid laser oscillators, double-frequency YAG laser oscillators, He—Ne laser oscillators and Kr laser oscillators. Among these, the gas laser oscillators and semiconductor laser oscillators for blue region are preferable.

The method for irradiating the informing light and the reference light may be properly selected depending on the purpose; for example, one laser light or beam is divided and irradiated for the informing light and the reference light, or two laser lights or beams may be irradiated from different sources.

The irradiating direction of the informing light and the reference light may be properly selected depending on the purpose; for example, the informing light and the reference light may be irradiated from different directions or in a same direction. In addition, the lights may be irradiated in a manner that the optical axis of the informing light and the optical axis of the reference light are coaxial.

The recording may be fixed and the interference image may be stabilized by way of a fixing light is irradiated onto the recording layer after the informing light and the reference light are irradiated and information is recorded on the recording layer.

The region onto which the fixing light irradiates may be properly selected depending on the purpose; preferably, the region may be the same region selected optionally to which is intended to record by the informing and reference lights, or the region may be from the outer boundary of the intended recording portion up to 1 μm outside of the boundary. When the fixing light is irradiated to the region beyond 1 μm apart from the outside of the boundary, the adjacent recording regions may be also irradiated, thus the irradiation energy is excessive and non-effective.

The irradiating period of the fixing light may be properly selected depending on the purpose; preferably, the period is 1 ns to 100 ms at the optional region of the recording layer, more preferably 1 ns to 80 ms. When the irradiating period is shorter than 1 ns, the fixing may be insufficient, and when longer than 100 ms, the irradiation may result in excessive-energy exposure.

The irradiating direction of the fixing light may be properly selected depending on the purpose; for example, the direction may be the same or different with that of the informing and reference lights irradiating the optional region of the recording layer described above. The irradiating angle is preferably 0° to 60° from normal of the recording layer, more preferably 0° to 40°. When the irradiating angle is outside the range, the fixing may be ineffective.

The wavelength of the fixing light may be properly selected depending on the purpose; preferably, the wavelength is 350 nm to 850 nm at the optional region of the recording layer described above, more preferably 400 nm to 600 nm. When the wavelength is shorter than 350 nm, the material may be decomposed, and when longer than 850 nm, the material may degrade due to higher temperatures.

The light source of the fixing light may be properly selected depending on the purpose; an incoherent light is preferably irradiated, examples thereof are the lights of fluorescent lamps, high-pressure mercury lamps, xenon lamps, light emission diodes, or lights of which the phase being randomized starting from a coherent light e.g. by passing through a forested glass. Among these, preferable are the lights from emission diodes and the lights of which the phase being randomized starting from a coherent light e.g. by passing through a forested glass.

The irradiation amount of the fixing light may be properly selected depending on the purpose; preferably, the irradiation amount is 0.001 J/cm² to 1 J/cm² at the optional region of the recording layer described above, more preferably 0.01 J/cm² to 0.3 J/cm².

The method for irradiating the fixing light may be properly selected depending on the purpose; for example, the fixing light may be irradiated from the same or different light source with that irradiates the informing and reference lights at the optional region of the recording layer described above.

Recording Layer

The recording layers contain the optical recording compositions according to the present invention.

The recording layers may be properly formed by conventional processes depending on the material; the preferable process for forming the layers is, for example, vapor deposition process, wet film-forming process, MBE (molecular beam epitaxy) process, cluster ion beam process, molecular laminating process, LB process, printing process and transfer process. In addition, the process for forming two-component urethane matrix described in U.S. Pat. No. 6,743,552 may be employed.

The recording layers may be formed by a wet film forming process, for example, in a manner that materials for the recording layer are dissolved and/or dispersed in a solvent to form a coating solution, then the coating solution is applied and dried. The wet film forming process may be properly selected depending on the purpose from conventional ones; examples thereof include an ink jet process, spin coating process, kneader coating process, bar coating process, blade coating process, casting process, dipping process and curtain coating process.

The thickness of the recording layers may be properly selected depending on the purpose; the thickness is preferably 1 μm to 1500 μm, more preferably 100 μm to 700 μm. When the thickness of the recording layer is within the preferable range, sufficient S/N ratio may be attained even on the shift multiplex of 10 to 300; and the more preferable range may advantageously lead to more significant effect thereof.

Support

The supports may be properly selected depending on the purpose in terms of the shape, configuration, size etc.; the shape may be disc-like, card-like, flat plate-like or sheet-like; the configuration may be of single-layered or multi-layered; and the size may be appropriately selected depending on the size of the optical recording medium.

The materials of the supports may be properly selected from inorganic and organic materials. The materials of the supports may provide the optical recording medium with a certain mechanical strength; in the case of transparent type where the lights for recording and reproducing enter through the substrate, the material should be transparent at the wavelength region of the employed lights.

Examples of the inorganic materials include glasses, quartz glass and silicon. Examples of the organic materials include acetate resins such as triacetylcellulose; polyester resins, polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinylalcohol resins, polyvinylchloride resins, polyvinilidenechloride resins, polyacrylic resins, polylactic acid, papers with laminated plastic film and synthetic papers. They may be used alone or in combination of two or more. Among these, polycarbonate resins and acrylic resins are preferable in view of formability, optical properties and cost.

The supports described above may be appropriately synthesized or commercially available.

The thickness of the supports may be properly selected depending on the purpose; preferably, the thickness is 0.1 mm to 5 mm, and more preferably 0.3 mm to 2 mm. When the thickness of the support is less than 0.1 mm, the disk may not resist the distortion of shape during storing, and when the thickness is more than 5 mm, the weight of the disk becomes heavy, thus excessive load may be applied to devices such as driving motors when the disk is rotated by means of them.

Second Embodiment

The second embodiment is utilized for Collinear system in which the informing light and the reference light are irradiated in a manner that the optical axis of the informing light is coaxial with the optical axis of the reference light; and the second embodiment is exemplified by a optical recording medium that comprises a first substrate, a second substrate, a recording layer on the second substrate, and a filter layer between the first and second substrates.

Optical Recording Method and Reproducing Method in Second Embodiment

The optical recording method in the second embodiment is an optical recording method founded on so-called Collinear system in which an informing light and a reference light are irradiated as a coaxial light beam, and information is recorded on the optical recording layer by an interference pattern generated by the interference between the informing light and the reference light.

The reproducing method may be properly selected depending on the purpose; for example, the same light with the reference light may be irradiated onto the interference image formed in the recording layer by the optical recording method described above, thereby to reproduce the recorded information corresponding to the interference image.

In the optical recording method and the reproducing method of the second embodiment, the informing light with a two-dimensional intensity distribution and the reference light with almost the same intensity to that of the informing light are superimposed inside the recording layer, the resulting interference pattern formed inside the recording layer induces a distribution of the optical properties of the recording layer to thereby record such distribution as an information. On the other hand, when the recorded information is to be read (reproduced), only the reference light is irradiated onto the recording layer from the same direction to that irradiated at the time of recording, a light having a intensity distribution corresponding to the distribution of the optical property formed inside the recording layer is emitted from the recording layer as a diffracted light.

The optical recording method and the reproducing method of the second embodiment may be carried out by use of the optical recording and reproducing apparatus explained below.

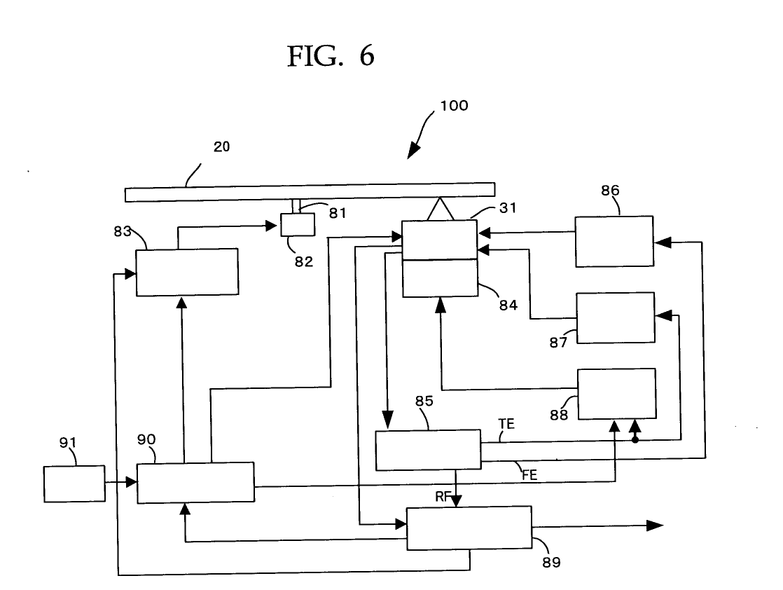

The optical recording and reproducing apparatuses applied to the optical recording method and the reproducing method will be explained with reference to FIG. 6.

FIG. 6 is an exemplary block flowchart showing a whole mechanism of a optical recording and reproducing apparatus of the second embodiment. The optical recording and reproducing apparatus contains both of an optical recording apparatus and an optical reproducing apparatus.

This optical recording and reproducing apparatus 100 is equipped with spindle 81 on which the optical recording medium 22 is deposed, spindle motor 82 which rotates the spindle 81, and spindle servo circuit 83 which controls the spindle motor 82 so as to maintain the optical recording medium 22 at a predetermined rotation number.

The optical recording and reproducing apparatus 100 is also equipped with pickup 31 which irradiates the informing light and the reference light onto the optical recording medium 22 so as to record information, and irradiates the reproducing reference light onto the optical recording medium 22 so as to detect the diffracted light to thereby reproduce the information recorded at the optical recording medium 22, and driving unit 84 which enables the pickup 31 to move in the radius direction of optical recording medium 22.

The optical recording and reproducing apparatus 100 is equipped with detecting circuit 85 which detects focusing error signal FE, tracking error signal TE, and reproducing signal RF from the output signal of the pickup unit 31, focusing servo circuit 86 which drives an actuator in the pickup unit 31 so as to move an objective lens (not shown) to the thickness direction of the optical recording medium 22 based upon the focusing error signal FE detected by the detecting circuit 85 to thereby perform focusing servo, a tracking servo circuit 87 which drives an actuator in the pickup unit 31 so as to move an objective lens (not shown) to the thickness direction of the optical recording medium 22 based upon the tracking error signal TE detected by the detecting circuit 85 to thereby perform tracking servo, and a sliding servo unit 88 which controls the driving unit 84 based upon the tracking error signal TE and an indication from a controller mentioned hereinafter so as to move the pickup unit 31 to the radius direction of the optical recording medium 22 to thereby perform sliding servo.

The optical recording and reproducing apparatus 100 is also equipped with signal processing circuit 89 which decodes output data of the CMOS or CCD array described below in the pickup unit 31, to thereby reproduce the data recorded in the data area of the optical recording medium 21, and to reproduce the standard clock or determines the address based on the reproducing signal RF from the detecting circuit 85, controller 90 which controls the whole optical recording and reproducing apparatus 100, and controlling unit 91 which gives various instructions to the controller 90.

The controller 90 is configured to input the standard clock or address information outputted from the signal processing circuit 89 as well as to control the pickup unit 31, the spindle servo circuit 83, the sliding servo circuit 88 and the like. The spindle servo circuit 83 is configured to input the standard clock outputted from the signal processing circuit 89. The controller 90 contains CPU (center processing unit), ROM (read only memory), and RAM (random access memory), the CPU realizes the function of the controller 90 by executing programs stored in the ROM on the RAM, a working area.

In the optical recording and reproducing apparatus utilized for the optical recording method and reproducing method of the second embodiment, the inventive optical recording medium is employed, interference stripes are recorded by an informing light and a reference light, then a fixing light is irradiated onto intended portions of the recording layer and as required the fixing is carried out sufficiently by other optional means without affecting the sensitivity at non-recorded portions.

Recording Layer

The recording layer contains the optical recording composition according to the present invention. The method for forming the recording layer may be substantially the same as the first embodiment.

In addition, the recording layer may be formed by way of providing the first substrate or the second substrate with a spacer, the optical recording composition is applied to the substrate to which the spacer being provided, then the substrate with no spacer is adhered to the optical recording composition as well as another substrate.

The spacer may be an outside spacer which being provided at outer edge of the optical recording medium in order to maintain the thickness of the recording layer or an inside spacer which being provided at around a center hole of the optical recording medium in order to maintain the thickness of the recording layer. Both of the inside and outside are preferably provided, meanwhile one of them may be omitted in some cases.

The shape, size and material of the spacer may be properly selected depending on the application. The shape of the cross section of the spacer may be square, rectangular, trapezoidal, circular, ellipsoidal or the like. The thickness of the spacer depends on the thickness of the recording layer; in general, the thickness is preferably 1 μm to 1500 μm. The material of the spacer may be properly selected depending on the application; preferably, the material is the same as that of the substrate.

The spacer may be provided to one of the first substrate and the second substrate or both of the substrates.

The spacer may be adhered to the substrate by an adhesive, or the spacer and the substrate may be shaped integrally. In cases where the material of the spacer is a resin, the molding process may be properly selected from conventional resin-molding processes.

A concave portion may be formed by the substrate and the spacer. Specifically, an inside spacer and/or an outside spacer is disposed on the first substrate to form the concave portion, or an inside spacer and/or an outside spacer is disposed on the second substrate to form the concave portion.

The material for the recording layer is applied to the concave portion. Preferably, the amount of the material for the recording layer is such an amount as the cured surface of the recording layer and the spacer surface represent a flat surface, which requires a somewhat excessive amount of the material for the recording layer corresponding to the shrinkage volume upon curing thereof, thereby the thickness of the recording layer may be uniformed and optimized even after the shrinkage due to the curing.

First and Second Substrates

The substrates may be properly selected depending on the purpose as for the shape, configuration, size etc.; the shape may be disc-like, card-like etc.; the material is required for the mechanical strength in terms of the optical recording media. In the case that the light for recording or reproducing is directed through the substrate, it is necessary that the substrate is sufficiently transparent at the wavelength region of the employed light.

The material of the substrate is usually selected from glasses, ceramics, resins etc.; preferably, resins are employed in particular from the view point of formability and cost. Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics and costs. The substrate may be properly prepared or commercially available.

Plural address-servo areas, i.e. addressing areas linearly extending in the radial direction of the substrate, are provided on the substrate at a given angle to one another, and each sector-form area between adjacent address-servo areas serves as a data area. In the address-servo areas, information for a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits are used as the information for tracking servo. The servo pit pattern is not necessarily required in the case that the optical recording medium is card-like shape.

The thickness of the substrate may be properly selected depending on the purpose; the thickness is preferably 0.1 mm to 5 mm, more preferably 0.3 mm to 2 mm. When the thickness of the substrate is less than 0.1 mm, the optical disc may be deformed during its storage; and when the thickness is more than 5 mm, the weight of the optical disc may be as heavy as excessively loading on the drive motor.

Reflective Film

The reflective film is formed on the surface of the servo pit pattern of the substrate. As for the materials of the reflective film, such materials are preferable that provide the recording light and the reference light with high reflectivity. When the wavelength of light is 400 nm to 780 nm, Al, Al alloys, Ag, Ag alloys and the like are preferably used. When the wavelength of light is 650 nm or more, Al, Al alloys, Ag, Ag alloys, Au, Cu alloys, TiN and the like are preferably used.

By use of DVD (digital video disc), for example, as the optical recording medium capable of reflecting the light and also recording and erasing information, such directory information as those indicative of the locations where information being recorded, the time when the information being recorded, and the locations where errors being occurred and exchanged can be recorded and erased without adversely affecting holograms.

The process for forming the reflective film may be properly selected depending on the purpose; examples thereof include various types of vapor deposition, such as vacuum vapor deposition, sputtering, plasma CVD, photo CVD, ion plating, and electron beam vapor deposition. Among these, sputtering is most preferable in view of mass productivity, film quality, and the like. The thickness of the reflective film is preferably 50 nm or more, more preferably 100 nm or more, in order to secure sufficient reflectivity.

Other Members

The other members described above may be, for example, the filter layer, a first gap layer, a second gap layer, and optional other layers.

Filter Layer

The filter layer is preferably provided between the second substrate and the recording layer in cases where the optical recording medium comprises the first substrate, the second substrate, and the recording layer on the second substrate.

The filter layer may perform to prevent diffuse reflection of the informing light and the reference light from the reflective film of the optical recording medium and to prevent noise generation without the sift of selective reflection wavelength even if the incident angle being altered; therefore, the lamination of the filter layer with the optical recording medium may achieve optical recording with excellently high resolution and diffraction efficiency.

Preferably, the filter layer transmits the first light and reflects the second light different from the first light; preferably, the wavelength of the first light is 350 nm to 600 nm and the wavelength of the second light is 600 nm to 900 nm. In this connection, the construction of the optical recording media is preferably such that the recording layer, filter layer and servo pit pattern are laminated in this order from the optical system side.

In addition, the filter layer represents the light transmissivity of 50% or more for 655 nm at the incident angle of ±40°, preferably 80% or more, and the light reflectivity of 30% or more for 532 nm, preferably 40% or more.

The filter layer may be properly selected depending on the purpose; for example, the filter layer may be formed of a laminated body containing a vapor-deposited dielectric layer, a cholesteric layer of mono layer or two or more layers, and other layers properly selected as required. The filter layer may also contain a color material-containing layer, for which JP-A No. 2006-184897 is incorporated into by reference.

The filter layer may be laminated directly to the support by way of coating etc. along with the recording layer; alternatively, a filter for optical recording media is prepared by laminating on a base material such as films, then the filter for optical recording media may be laminated on the support.

Vapor-Deposited Dielectric Layer

The vapor-deposited dielectric layer is formed from a laminate of plural dielectric thin layers having different refractive indices each other. For the vapor-deposited dielectric layer to serve as a wavelength-selective reflection film, a laminate is preferable that contains alternating dielectric thin layers with higher and lower refractive indices; in this connection, three or more different dielectric thin layers may be laminated. When the color material-containing layer is disposed, it is disposed under the vapor-deposited dielectric layer.

The number of the laminated layers is preferably 2 to 20, more preferably 2 to 12, still further preferably 4 to 10, and most preferably 6 to 8. When the number of the laminated layers is greater than 20, the productivity may degrade because of multilayer vapor deposition, and the object and effect of the present invention may hardly be achieved.

The order for laminating the dielectric thin layers may be properly selected depending on the purpose. For example, a dielectric thin layer with lower refractive indices is deposited first in a case where the adjacent dielectric thin layer has a higher refractive index; on the other hand, a dielectric thin layer with a higher refractive index is deposited first in a case where the adjacent dielectric thin layer has a lower refractive index. The threshold of refractive index for determining whether a dielectric thin layer has a high or low refractive index is preferably defined as 1.8. This determination is made on an arbitrary basis; that is, among higher refractive-index materials, there may exist materials with relatively higher or lower refractive indices, and these materials may exist alternatively.

The materials for the dielectric thin layer with higher refractive indices may be properly selected depending on the purpose without limitation; examples thereof include Sb₂O₃, Sb₂S₃, Bi₂O₃, CeO₂, CeF₃, HfO₂, La₂O₃, Nd₂O₃, Pr₆O₁₁, Sc₂O₃, SiO, Ta₂O₅, TiO₂, TlCl, Y₂O₃, ZnSe, ZnS and ZrO₂. Among these, Bi₂O₃, CeO₂, CeF₃, HfO₂, SiO, Ta₂O₅, TiO₂, Y₂O₃, ZnSe, ZnS and ZrO₂ are preferable, and SiO, Ta₂O₅, TiO₂, Y₂O₃, ZnSe, ZnS and ZrO₂ are more preferable.

The material for the dielectric thin layer with lower refractive indices may be properly selected depending on the purpose without limitation; examples thereof include Al₂O₃, BiF₃, CaF₂, LaF₃, PbCl₂, PbF₂, LiF, MgF₂, MgO, NdF₃, SiO₂, Si₂O₃, NaF, ThO₂ and ThF₄. Among these, Al₂O₃, BiF₃, CaF₂, MgF₂, MgO, SiO₂ and Si₂O₃ are preferable, and Al₂O₃, CaF₂, MgF₂, MgO, SiO₂ and Si₂O₃ are more preferable.

The atomic ratio in the material for the dielectric thin layer may also be properly selected depending on the purpose; the atomic ratio may be adjusted by changing the gas concentration of atmosphere upon deposition of dielectric thin layers.

The method for producing the dielectric thin layers may be properly selected depending on the purpose; examples of the method include vacuum vapor deposition processes such as ion plating and ion beam, physical vapor deposition (PVD) such as sputtering, and chemical vapor deposition (CVD). Among these methods, vacuum vapor deposition and sputtering are preferable, and the sputtering is most preferable.

As for the sputtering, DC sputtering is preferable because it offers high deposition rate. Preferably, highly conductive material is used when DC sputtering is employed.

Examples of the method for depositing multiple dielectric thin layers by sputtering include single-chamber method, where multiple dielectric thin layers are alternately or sequentially deposited using a single chamber, and multi-chamber method, where multiple dielectric thin layers are sequentially deposited using multiple chambers. In view of the productivity and to prevent contamination among materials, the multi-chamber method is most preferable.

The thickness of the dichroic mirror layer is preferably λ/16 to λ, more preferably λ/8 to 3λ/4, most preferably λ/6 to 3λ/8 in terms of optical wavelength order.

Cholesteric Liquid Crystal Layer

The cholesteric liquid crystal layer comprises at least a cholesterol derivative or a nematic liquid crystal compound and a chiral compound, and a polymerizable monomer and other ingredients as required. The cholesteric liquid crystal layer may be of a mono-layer or plural-layer cholesteric liquid crystal layer.

Preferably, the cholesteric liquid crystal layer displays a circularly polarizing function. The cholesteric liquid crystal layer selectively reflects light components, which are circularly polarized in the direction to which the liquid crystal helix rotates (i.e., to the right or left) and which have a wavelength equal to the pitch of the liquid crystal helix. The cholesteric liquid crystal layer utilizes the selective-reflection characteristics to separate a particular circularly polarized component of a particular wavelength from natural light of different wavelengths, and reflects the other light components.

The filter layer for optical recording media preferably has an optical reflectivity of 40% or more for a wavelength range of λ₀ to λ₀/cos 20° (where λ₀ represents the wavelength of irradiation light) incident at an angle of ±20° (measured from the normal of the surface of the recording layer). Most preferably, the filter layer for optical recording media has an optical reflectivity of 40% or more for a wavelength range of λ₀ to λ₀/cos 40° (where λ₀ represents the wavelength of irradiation light) incident at an angle of ±40° (measured from the normal of the surface of the recording layer). When the optical reflectivity is 40% or more for a wavelength range of λ₀ to λ₀/cos 20°, especially λ₀ to λ₀/cos 40° (where λ₀ represents the wavelength of irradiation light), the angle dependency to reflect the irradiation light may be eliminated and thus conventional optical lens systems for usual optical recording media may be employed. For the purpose, it is preferred that the cholesteric liquid crystal layer represents a wider wavelength width of the selective reflection region.

Specifically, liquid crystals having larger (ne−no) are preferable since the wavelength width Δλ of the selective reflection region may be expressed by the Equation (1) below.
Δλ=2λ(ne−no)/(ne+no): Equation (1)

in which “no” represents the refractive index of the nematic liquid crystal molecules for normal light, contained in the cholesteric liquid crystal layer, “ne” represents the refractive index of the nematic liquid crystal molecules for abnormal light, and λ represents the central wavelength of light selectively reflected.

It is also preferred that a photoreactive chiral compound, having a photosensitive property and capable of significantly changing the spiral pitch of liquid crystal through the action of light, is employed as the chiral as described in JP-A No. 2006-162814, and a filter for optical recording media is employed of which the spiral pitch alters successively in the thickness direction of the liquid crystal layer by adjusting the content of the photoreactive chiral compound and UV irradiation time.

In the case of plural layers of cholesteric liquid crystal layers, it is preferred that cholesteric liquid crystal layers are laminated of which the central wavelengths of the selective reflectivity are different each other and of which the helical rotation directions are the same each other.

The cholesteric liquid crystal layers may be properly selected depending on the purpose as long as satisfying the properties described above; the cholesteric liquid crystal layers contain a nematic liquid crystal compound and a chiral compound, and further contain polymerizing monomers and other ingredients as required.

Nematic Liquid Crystal Compound

The nematic liquid crystal compounds feature that their liquid crystal phase solidifies under their liquid crystal transition temperatures, and may be properly selected from liquid crystal compounds, high-molecular liquid crystal compounds and polymerizable liquid crystal compounds, all of which have refractive index anisotropy Δn of 0.10 to 0.40. For example, molecules of such nematic liquid crystal compounds in a liquid crystal state may be aligned on a substrate treated for the alignment such as rubbing, followed by cooling to immobilize the molecules for an available solid phase.

Among the exemplified compounds, the nematic liquid crystal compounds are preferably those having at least a polymerizable group per molecule from the view point of assuring sufficient curing ability. Among these, ultraviolet (UV) polymerizable liquid crystal compounds are preferable. Such UV polymerizable liquid crystal compounds are commercially available; examples thereof include PALIOCOLOR LC242 (product name, by BASF Corp.), E7 (product name, by Merck Ltd.), LC-Silicon-CC3767 (product name, by Wacker-Chemie GmbH), and L35, L42, L55, L59, L63, L79 and L83 (product name, by Takasago International Corp.).

The content of the nematic liquid crystal compound is preferably 30% by mass to 99% by mass, more preferably 50% by mass to 99% by mass based on the total solid mass of each of the cholesteric liquid crystal layers. When the content of the nematic liquid crystal compound is less than 30% by mass, the alignment of nematic liquid crystal molecules may be insufficient.

Chiral Compound

The chiral compound may be properly selected from conventional ones depending on the purpose in the case of plural layers of cholesteric liquid crystal layers in particular; examples thereof include isomannide compounds, catechine compounds, isosorbide compounds, fenchone compounds and carvone compounds in view of the hues of the liquid crystal compounds and for enhanced color purity. These compounds may be used alone or in combination of two or more.

In addition, commercially available chiral compounds may be available; examples thereof include S101, R811 and CB15 (product name, by Merck Ltd.); and PALIOCOLOR LC756 (product name, by BASF Corp.).

The content of the chiral compounds in the respective liquid crystal layers is preferably no more than 30% by mass based on the total solid mass of each of the cholesteric liquid crystal layers, more preferably no more than 20% by mass. When the content of the nematic liquid crystal compound is more than 30% by mass, the alignment of cholesteric liquid crystal layers may be insufficient.

Polymerizable Monomer

Polymerizable monomers may be additionally included to the cholesteric liquid crystal layer in order to, for example, increase the curing level such as film strength. Additional use of polymerizable monomers may increase the strength of the cholesteric liquid crystal layer, in a way that twisting degrees of liquid crystals are altered through which a light propagates (e.g., after the distribution of selection wavelength being created) and the helical structure (i.e., selective reflection capability) is fixed. When the liquid crystal compound bears polymerizable groups in a molecule, such additional polymerizable monomers are not necessarily required.

The polymerizable monomers may be properly selected from conventional ones depending on the purpose; examples thereof include monomers with ethylenically unsaturated bonds, more specifically, multifunctional monomers such as pentaerythritoltetraacrylate and dipentaerythritolhexaacrylate. These may be used alone or in combination of two or more.

The content of the polymerizable monomers is preferably no more than 50% by mass, more preferably 1% by mass to 20% by mass based on the total solid mass of the cholesteric liquid crystal layer. When the content the polymerizable monomers is more than 50% by mass, the alignment may be inhibited in the cholesteric liquid crystal layer.

Other Ingredients

The other ingredients may be properly selected depending on the purpose; examples thereof include photopolymerization initiators, sensitizers, binder resins, polymerization inhibitors, solvents, surfactants, thickeners, dyes, pigments, ultraviolet absorbers and gelling agents.

The photopolymerization initiators may be properly selected from conventional ones without limitation; examples thereof include p-methoxyphenyl-2,4-bis(trichloromethyl)-s-triazine, 2-(p-buthoxystyryl)-5-trichloromethyl-1,3,4-oxadiazole, 9-phenylacridine, 9,10-dimethylbenzphenazine, benzophenone/Michler's ketone, hexaarylbiimidazole/mercaptobenzoimidazole, benzyldimethylketal and thioxanthone/amine. These may be used alone or in combination of two or more.

The photopolymerization initiators may be commercially available; examples thereof include Irgacure 907, Irgacure 369, Irgacure 784 and Irgacure 814 (product name, by Ciba Specialty Chemicals); and Lucirin TPO (product name, by BASF Corp.).

The content of the photopolymerization initiator is preferably 0.1% by mass to 20% by mass, more preferably 0.5% by mass to 5% by mass based on the total solid mass of the cholesteric liquid crystal layer. When the content of the photopolymerization initiator is less than 0.1% by mass, it may take long time for the polymerization because of reduced curing efficiency upon irradiation with light. When the content of the photopolymerization initiator is more than 20% by mass, it may result in poor optical transmittance over the spectrum from ultraviolet to visible light.

The sensitizer is added as required in order to increase the cure level in the cholesteric liquid crystal layer. The sensitizer may be properly selected from conventional ones depending on the purpose; examples thereof include diethylthioxanthone and isopropylthioxanthone. The content of the sensitizer is preferably 0.001% by mass to 1% by mass based on the total solid mass of the cholesteric liquid crystal layer.

The binder resin may be properly selected from conventional ones depending on the purpose without limitation; examples thereof include polyvinyl alcohols; polystyrene compounds such as polystyrene and poly-alpha-methylstyrene; cellulose resins such as methylcellulose, ethylcellulose and acetylcellulose; acid cellulose derivatives having a carboxylic group on their side chains; acetal resins such as polyvinyl formal and polyvinyl butyral; methacrylic acid copolymers; acrylic acid copolymers; itaconic acid copolymers; crotonic acid copolymers; malleic acid copolymers; partially-esterified malleic acid copolymers; homopolymers of acrylic acid alkylesters or homopolymers of methacrylic acid alkyl esters; and polymers having a hydroxyl group. These binder resins may be used alone or in combination of two or more.

Examples of alkyl groups in the homopolymers of acrylic acid alkylesters or homopolymers of methacrylic acid alkyl esters include methyl group, ethyl group, n-propyl group, n-butyl group, isobutyl group, n-hexyl group, cyclohexyl group and 2-ethylhexyl group.

Examples of the polymers having hydroxyl group include benzyl(meth)acrylate/(methacrylic acid homopolymers)acrylic acid copolymers, and multicomponent copolymers of benzyl(meth)acrylate/(meth)acrylic acid/other monomers.

The content of the binder resin is preferably no more than 80% by mass based on the total solid mass of the cholesteric liquid crystal layer, more preferably no more than 50% by mass. When the content the polymerizable monomers is more than 80% by mass, the alignment may be insufficient in the cholesteric liquid crystal layer.

The polymerization inhibitor may be properly selected depending on the purpose without limitation; examples thereof include hydroquinones, hydroquinone monoethylethers, phenothiazines, benzoquinones and derivatives thereof. The content of the polymerization inhibitor is preferably 10% by mass or less, more preferably 0.01% by mass (100 ppm) to 1% by mass based on the total solid content of the polymerizable monomer.

The solvent may be properly selected from conventional ones depending on the purpose; examples thereof include alkoxypropionic acid esters such as 3-methoxypropionic acid methylester, 3-methoxypropionic acid ethylester, 3-methoxypropionic acid propylester, 3-ethoxypropionic acid methylester, 3-ethoxypropionic acid ethylester and 3-ethoxypropionic acid propylester; alkoxy alcohol esters such as 2-methoxypropylacetate, 2-ethoxypropylacetate and 3-methoxybutylacetate; lactic acid esters such as methyl lactate and ethyl lactate; ketones such as methyl ethyl ketone, cyclohexanone and methylcyclohexanone; γ-butyrolactone, N-methylpyrrolidone, dimethylsulfoxide; chloroform and tetrahydrofuran. These solvents may be used alone or in combination.

The cholesteric liquid crystal layer may be formed in the following procedure: for example, a coating liquid for cholesteric liquid crystal layer prepared by use of solvents described above is applied on the base material, or respective coating liquids are applied in the case of a multilayered cholesteric liquid crystal layer, thereafter, the coating liquid is dried and cured by irradiating it with UV rays.

For mass production, the cholesteric liquid crystal layer can be formed in the following procedure: the base material is previously wound in a roll shape, then the coating liquid is applied on the base material using a long, continuous coater such as bar coater, die coater, blade coater and curtain coater.

Examples of the coating method include spin coating method, casting method, roll coating method, flow coating method, printing method, dip coating method, casting deposition method, bar coating method and gravure printing method.

The UV irradiation condition is not particularly limited and can be appropriately determined depending on the purpose; the wavelength of UV rays is preferably 160 nm to 380 nm, more preferably 250 nm to 380 nm; irradiation time is preferably 0.1 second to 600 seconds, more preferably 0.3 second to 300 seconds. By adjusting the UV irradiation condition, it is possible to change the helical pitch of the cholesteric liquid crystal layer continuously in the thickness direction of the liquid crystal layer.

It is also possible to add an ultraviolet absorber to the cholesteric liquid crystal layer in order to adjust the UV irradiation condition. The ultraviolet absorber is not particularly limited and can be appropriately selected depending on the intended purpose; suitable examples thereof include benzophenone ultraviolet absorbers, benzotriazole ultraviolet absorbers, salicylic acid ultraviolet absorbers, cyanoacrylate ultraviolet absorbers and oxalic acid anilide ultraviolet absorbers. Specific examples of these ultraviolet absorbers are disclosed in JP-A Nos. 47-10537, 58-111942, 58-212844, 59-19945, 59-46646, 59-109055 and 63-53544; JP-B Nos. 36-10466, 42-26187, 48-30492, 48-31255, 48-41572, 48-54965 and 50-10726; and U.S. Pat. Nos. 2,719,086, 3,707,375, 3,754,919 and 4,220,711.

In the case of the multilayered cholesteric liquid crystal layer, the thickness of each cholesteric liquid crystal layer is preferably 1 μm to 10 μm, and is more preferably 2 μm to 7 μm. When the thickness of the cholesteric liquid crystal layer is less than 1 μm, it results in poor selective reflectivity. When the thickness of the cholesteric liquid crystal layer is more than 10 μm, uniformly aligned liquid crystal molecules may orient in random directions in the cholesteric liquid crystal layer.

The total thickness of the cholesteric liquid crystal layer in a multilayered cholesteric liquid crystal layer (or the thickness of a single-layered liquid crystal layer) is preferably 1 μm to 30 μm, and is more preferably 3 μm to 10 μm.

Method of Producing Filter for Optical Recording Media Containing Cholesteric Layer

The method of producing the filter for optical recording media may be properly selected depending on the purpose. The filter for optical recording media may be properly selected depending on the purpose; preferably, the filter is processed into disc-shape by punching through and arranged on the second substrate of the optical recording medium. When applied as the filter layer for optical recording media, it can be directly arranged on the second substrate without a base material.

Base Material

The base material may be properly selected depending on the purpose; for example, the same material as for the support in the first embodiment may be also used.

The base material may be properly prepared or commercially available. The thickness of the base material may be properly selected depending on the purpose; preferably the thickness is 10 μm to 500 μm, more preferably 50 μm to 300 μm. When the thickness of the base material is less than 10 μm, the adhesiveness may be lower due to deflection of the substrate, and when over 500 μm, the focus sites of the informing light and the reference light are required to shift considerably, which leading to larger size of the optical system.

In order to laminate to form the cholesteric liquid crystal layer, conventional adhesives or tackiness agents may be properly selected or combined as required.

The tackiness agent may be properly selected depending on the purpose; examples thereof include rubber agents, acrylic agents, silicone agents, urethane agents, vinylalkyl ether agents, polyvinylalcohol agents, polyvinylpyrrolidone agents, polyacrylamide agents and cellulose agents.

The thickness of the adhesives or tackiness agents may be properly selected depending on the purpose. In the case of adhesives, the thickness is preferably 0.1 μm to 10 μm, more preferably 0.1 μm to 5 μm in light of the optical characteristics and slimness. In the case of tackiness agents, the thickness is preferably 1 μm to 50 μm, more preferably 2 μm to 30 μm.

In addition, the filter layer can be formed directly on the substrate on occasion.

First Gap Layer

The first gap layer is provided between the filter layer and the reflective film as required for smoothing the surface of the substrate. Moreover, the first gap layer is effective to adjust the size of the hologram formed in the recording layer. Specifically, the gap layer between the recording layer and the servo pit pattern may be effective, since the recording layer requires the interference region of some larger size between the recording reference light and the informing light.

The first gap layer can be formed by, for example, applying UV curable resin etc. on the servo pit pattern by spin coating etc. and by curing the resin. In addition, when a filter layer is formed on a transparent base material, the transparent base material also serves as the first gap layer. The thickness of the first gap layer may be properly selected depending on the purpose; the thickness is preferably 1 μm to 200 μm.

Second Gap Layer

The second gap layer may be provided between the recording layer and the filter layer as required.

The material for the second gap layer may be properly selected depending on the purpose; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (product name, by JSR Corp.), ZEONOA (product, by Nippon Zeon). Among these, those with higher isotropy are preferable, and TAC, PC, ARTON and ZEONOA are most preferable.

The thickness of the second gap layer may be properly selected depending on the purpose; the thickness is preferably 1 μm to 200 μm.

Hereinafter, embodiments of the optical recording medium of the present invention, which includes the reflective film and the first and second gap layers, will be described in detail with reference to the drawings.

Specific Examples of Optical Recording Media

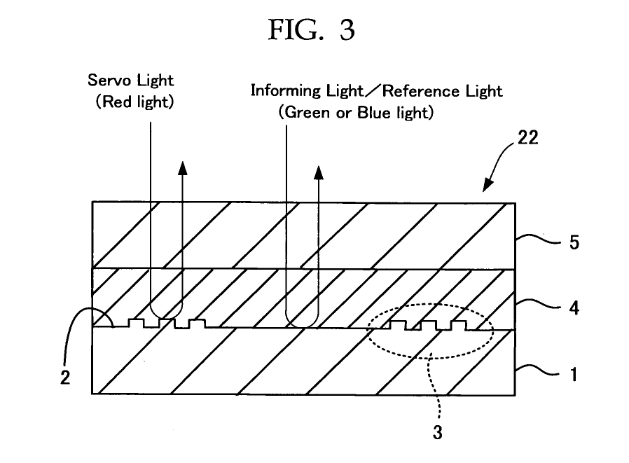

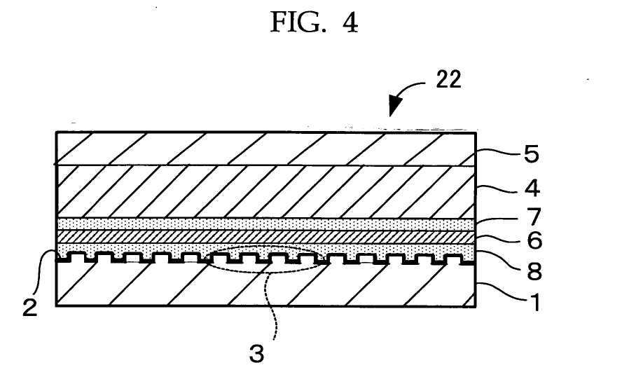

FIG. 4 is a schematic cross-sectional view showing a structure of the first embodiment of the optical recording medium in the present invention. In the optical recording medium 22 according to the first embodiment, servo pit pattern 3 is formed on the second substrate 1 made of a polycarbonate resin or glass, and the servo pit pattern 3 is coated with Al, Au, Pt or the like to form reflective film 2. Although the servo pit pattern 3 is formed on the entire surface of the second substrate 1 in FIG. 4, it may be formed periodically as shown in FIG. 3. The height of the servo pit pattern 3 is usually 1750 angstroms (175 nm), which being significantly smaller than the other layers including the substrate.

The first gap layer 8 is formed by applying UV curable resin or the like on the reflective film 2 of the second substrate 1 by spin coating or the like. The first gap layer 8 is effective for protecting the reflective film 2 and for adjusting the size of holograms created in recording layer 4. Specifically, the interference region between the recording reference light and the informing light requires a level of size in the recording layer 4, a clearance is effectively provided between the recording layer 4 and the servo pit pattern 3.

The filter layer 6 is provided on the first gap layer 8, the second gap layer 7 is provided between the filter layer 6 and the first substrate 5 (polycarbonate resin or glass substrate), and the recording layer 4 is sandwiched to thereby constitute the optical recording medium 22.

In FIG. 4, the filter layer 6 transmits only red light and blocks other color lights. Since the informing light, recording light and reproducing reference light are of green or blue, they do not pass through the filter layer 6 instead turn into a return light to emit from the entrance/exit surface A without reaching the reflective film 2.

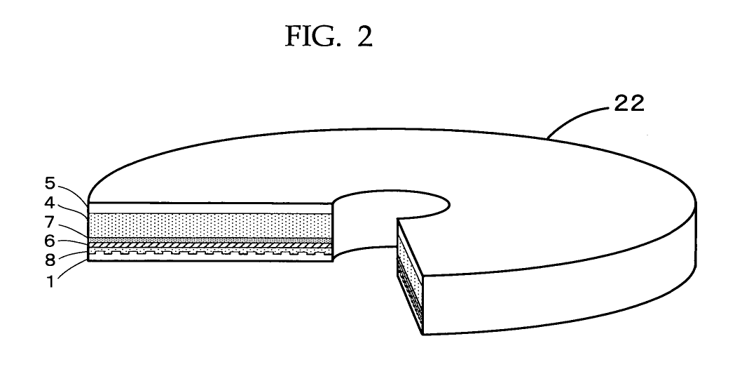

The optical recording medium 22 of the first embodiment may be of disc shape or card shape as shown in FIG. 2. The servo pit pattern is unnecessary in the case of card shape. In the optical recording medium 22, the second substrate 1 is 0.6 mm thick, the first gap layer 8 is 100 μm thick, the filter layer 6 is 2 μm to 3 μm thick, the recording layer 4 is 0.6 mm thick, and the first substrate 5 is 0.6 mm thick, leading to the total thickness of about 1.9 mm.

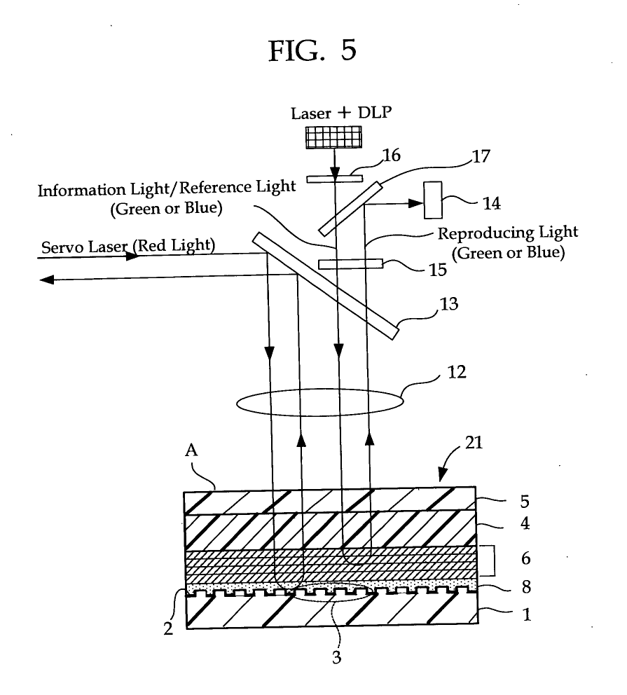

The optical operations around the optical recording medium 22 will be explained with reference to FIG. 5 in the following. Initially, red light emitted from the servo laser source is reflected by dichroic mirror 13 by almost 100%, and passes through objective lens 12. The servo light 10 is applied onto the optical recording medium 22 in such a way that it focuses on the reflective film 2. More specifically, the dichroic mirror 13 is configured to transmit only green or blue light but reflect almost 100% of red light. The servo light incident from the light entrance/exit surface A of the optical recording medium 22 passes through the first substrate 5, optical recording layer 4, second gap layer 7, filter layer 6 and first gap layer 8, then is reflected by the reflective film 2, and passes again through the first gap layer 8, filter layer 6, second gap layer 7, recording layer 4 and first substrate 5 to emit from the light entrance/exit surface A. The emitted return light passes through the objective lens 12 and is reflected by the dichroic mirror 13 by almost 100%, and then a servo information detector (not shown) detects servo information. The detected servo information is used for the focus servo operation, tracking servo operation, slide servo operation and the like. The hologram material constituting the recording layer 4 is designed so as not to be sensitive to red light, therefore, even when the servo light passes through the recording layer 4 or reflects diffusively at the reflective film 2, the recording layer 4 is not adversely affected. In addition, the return servo light reflected by the reflective film 2 is reflected almost 100% by the dichroic mirror 13, accordingly, the servo light is non-detectable by CMOS sensor or CCD 14 used for the detection of reconstructed images, thus providing the diffracted light with no noise.

Both of the informing light and the recording reference light emitted from the recording/reproducing laser source pass through the polarizing plate 16 to form a linear polarization then to form a circular polarization after passing through the half mirror 17 and the quarter wavelength plate 15. The circular polarization then passes through the dichroic mirror 13, and illuminates the optical recording medium 22 by action of the objective lens 12 in a manner that the informing light and the reference light create an interference pattern in the recording layer 4. The informing light and reference light enter from the light entrance/exit surface A and interact with each other in the recording layer 4 to form and record an interference pattern. Thereafter, the informing light and reference light enters into the recording layer 4 and the filter layer 6, and then, are reflected to turn into a return light before reaching the bottom of the filter layer 6. That is, the informing light and recording reference light do not reach the reflective film 2. This is because the filter layer 6 transmits exclusively red light. Alternatively, provided that the intensity of light leaking and transmitting from the filter can be suppressed to no more than 20% of the incident light, even when the leaking light reaches the bottom face and turns into a return light, the intensity of light intermixed with the diffracted light comes to no more than 4% (20%×20%) since the it being reflected at the filter layer again, thus no problem occurs substantially.

Method for Producing Optical Recording Medium

The method for producing a optical recording medium according to the present invention comprises at least a step of forming a recording layer, a step of forming a filter layer, a step of forming a reflective layer, and optional other steps.

Step of Forming Recording Layer

The recording layer is formed in this step as described above.

Step of Forming Filter Layer

In the step of forming a filter layer, the filter for optical recording media is processed into a shape of a optical recording medium, the resulting filter is laminated on the second substrate to form a filter layer. The method for producing the inventive filter for optical recording media is described above.

The shape of the optical recording medium may be, for example, disc-like or card-like. The method for processing the filter into the shape of the optical recording medium may be properly selected depending on the purpose; such processes may be employed as a cutting process with a press cutter and stamping process with a stamping cutter. In carrying out the lamination, for example, the filter is laminated to the substrate using an adhesive or tackiness agent in a manner of no air being entrapped therebetween.

The adhesive may be properly selected depending on the purpose; examples thereof include UV curable adhesives, emulsion adhesives, one-component curable adhesives and two-component curable adhesives. These conventional adhesives may also be employed in appropriate combination of two or more.

The tackiness agent may be properly selected depending on the purpose; examples thereof include rubber agents, acrylic agents, silicone agents, urethane agents, vinylalkyl ether agents, polyvinyl alcohol agents, polyvinyl pyrrolidone agents, polyacrylamide agents and cellulose agents.

The thickness of the adhesive or tackiness agent may be properly selected depending on the purpose; from the viewpoint of optical properties and demands for thinning, the thickness of the adhesive is preferably 0.1 μm to 10 μm, more preferably 0.1 μm to 5 μm and the thickness of the tackiness agent is preferably 0.1 μm to 50 μm, more preferably 2 μm to 30 μm.

It is possible to directly form the filter layer on the substrate depending on the circumstances. For example, a coating liquid for color material-containing layer is applied onto the substrate to form a color material-containing layer, and a dielectric vapor deposition film is formed on the color material-containing layer by a sputtering process.

Optical Recording and Reproducing Method

The inventive optical recording and reproducing method may be properly selected depending on the purpose; for example, the method comprises irradiating the same light from the same direction as the reference light at the recording onto the optical recording medium which being recorded by the optical recording method according to the present invention. Specifically, the light is irradiated to the interference image formed in the recording layer of the optical recording medium, thereby a diffracted light is generated with recorded information corresponding to the interference image, and the reproduction may be carried out by receiving the diffracted light.

### EXAMPLES

The present invention will be explained with reference to Examples, which are given for no more than illustration of the invention rather than for limiting its intended scope. Through this disclosure, all of percent (%) are expressed by mass unless otherwise indicated.

### Example 1

A precursor of optical recording composition was prepared in accordance with the formulation shown below, an optical recording composition was prepared from the precursor, then an optical recording medium was produced that had a laminated recording layer containing the optical recording composition. The resulting optical recording medium was recorded and evaluated as described below.

Preparation of Precursor

The ingredients shown below were mixed under nitrogen atmosphere to prepare the precursor of optical recording composition. The contents of the respective ingredients are solid contents expressed in terms of percent (%) by mass. The precursor of the composition contains at least a substance for a site to initiate a photopolymerization reaction and a polymerizable monomer, from which the inventive optical recording composition may be prepared through a heat-treatment thereof.

| | |
|---|---|
| Biscyclohexyl methanediisocyanate | 31.5% |
| Polypropyleneoxide triol¹⁾ | 58.86% |
| Tetramethylene glycol | 2.50% |
| 2,4,6-tribromophenyl acrylate | 3.10% |
| Photopolymerization Initiator²⁾ | 1.20% |
| 2,5-bis[(4-diethylamino-2-methylphenyl)methylene] | 0.03% |
| 2-mercaptobenzoxazole | 1.80% |
| Dibutyltindilaurate | 1.01% |

¹⁾molecular weight: 1000
²⁾Specific Compound 1

Preparation of Holographic Recording Medium

One surface of a glass sheet having a thickness of 0.5 mm was subjected to antireflection treatment so as to give a reflectivity of 0.1% with respect to a normal incident having a wavelength of 532 nm, to thereby obtain a first substrate. One surface of another glass sheet having a thickness of 0.5 mm was subjected to aluminum deposition so as to give a reflectivity of 90% with respect to a normal incident having a wavelength of 532 nm, to thereby obtain a second substrate.

Then, a spacer of transparent polyethylene terephthalate sheet having a thickness of 500 μm was disposed on the surface of the first substrate which being not subjected the antireflection treatment, then the precursor of the optical recording composition was applied on the first substrate. Then the side of the second substrate, where the aluminum being deposited, was contacted to the side of the precursor of the optical recording composition on the first substrate so as to trap no air therebetween, thereby the first substrate and the second substrate were laminated along with the spacer interposed therebetween. Finally, the laminate was allowed to stand at 45° C. for 24 hours to prepare an optical recording composition, thereafter an optical recording medium was prepared that contained optical recording composition.

Recording and Evaluation of Holographic Recording Medium

By means of Collinear hologram recording and reproducing examiner SHOT-1000 (by Pulsetec Industrial Co.), the resulting optical recording medium was subjected to writing a series of multiplex holograms with a recording spot diameter of 200 μm at the focal point of the hologram recording, which were measured and evaluated in terms of sensitivity (recording energy) and multiplicity.

Measurement of Sensitivity

The irradiation light energy (mJ/cm²) was varied at the recording, and a variation of bit error rate (BER) of the reproduction signal was measured. Generally speaking, as the power of the recording beam is increased, the brightness of the reproduction signal is increased, and the BER of the reproduction signal tends to gradually decrease. In this case, the recording photosensitivity was determined with respect to the minimum irradiation light energy which provided an approximately clear reproduced image (BER<10⁻³). The results are shown in Table 1.

Evaluation of Multiplicity

As a multiplicity evaluation for the hologram recording medium, a method described in “ISOM'04, Th-J-06, pp. 184-185, October 2004” was applied. In this method, a recording spot was made shifted in a spiral direction to evaluate the multiplicity. The number of the recorded hologram was set at 13×13=169 holograms, and the recording pitch was set at 28.5 μm. The multiplicity was 49 at the final (169th) hologram recording.

As the number of the recorded holograms is increased, the multiplicity is increased; therefore, insufficient multiplicity results in increase of the BER as the recorded number increases. Accordingly, the number of the recording hologram volume at BER>10⁻³ was determined as the multiplex property M of the hologram recording medium. The results are shown in Table 1.

Structural Analysis of Binder

The resulting optical recording medium was extracted using dioxane and analyzed by NMR and liquid chromatography. The analysis results demonstrated that the extract contains no Specific Compound No. 1 and the binder has a site to initiate a photopolymerization reaction.

### Example 2

An optical recording medium of Example 2 was prepared in the same manner as Example 1, except that 1.2% by mass of the photopolymerization initiator of Specific Compound 1 was changed into 1.2% by mass of the photopolymerization initiator of Specific Compound 4, then the sensitivity and the multiplicity thereof was evaluated and the structure of the binder prior to the photopolymerization reaction was analyzed. The results are shown in Table 1.

### Example 3

An optical recording medium of Example 3 was prepared in the same manner as Example 1, except that 1.2% by mass of the photopolymerization initiator of Specific Compound 1 was changed into 1.2% by mass of the photopolymerization initiator of Specific Compound 10, then the sensitivity and the multiplicity thereof was evaluated and the structure of the binder prior to the photopolymerization reaction was analyzed. The results are shown in Table 1.

### Example 4

A mixture consisting of 20% by mass of a photopolymerization initiator of Specific Compound 5, 20% by mass of 2-hydroxyethylacrylate, 0.08% by mass of azobisisobutyronitrile and 59.92% by mass of MEK was stirred at 80° C. for 6 hours under nitrogen atmosphere and then poured into hexane, thereby Photopolymerization Initiator A that bonds to a binder ingredient was obtained.

An optical recording medium of Example 4 was prepared in the same manner as Example 1, except that 1.2% by mass of the photopolymerization initiator of Specific Compound 1 was changed into 1.2% by mass of the Photopolymerization Initiator A, then the sensitivity and the multiplicity thereof was evaluated. The results are shown in Table 1.

### Example 5

An optical recording medium of Example 5 was prepared in the same manner as Example 4, except that 20% by mass of the photopolymerization initiator of Specific Compound 5 was changed into 20% by mass of the photopolymerization initiator of Specific Compound 9, then the sensitivity and the multiplicity thereof was evaluated. The results are shown in Table 1.

### Example 6

An optical recording medium of Example 6 was prepared in the same manner as Example 1, except that 1.2% by mass of the photopolymerization initiator of Specific Compound 1 was changed into 7% by mass thereof, then the sensitivity and the multiplicity thereof was evaluated. The results are shown in Table 1.

### Example 7

An optical recording medium of Example 7 was prepared in the same manner as Example 1, except that 1.2% by mass of the photopolymerization initiator of Specific Compound 1 was changed into 0.2% by mass thereof, then the sensitivity and the multiplicity thereof was evaluated. The results are shown in Table 1.

### Example 8

An optical recording medium of Example 8 was prepared in the same manner as Example 1, except that 1.2% by mass of the photopolymerization initiator of Specific Compound 1 was changed into 1.2% by mass of the photopolymerization initiator of Specific Compound 3, then the sensitivity and the multiplicity thereof was evaluated. The results are shown in Table 1.

### Example 9

A mixture consisting of 20% by mass of a photopolymerization initiator of Specific Compound 5, 20% by mass of n-butylacrylate, 0.08% by mass of azobisisobutyronitrile and 59.92% by mass of methylethylketone was stirred at 80° C. for 6 hours under nitrogen atmosphere and then poured into hexane, thereby Photopolymerization Initiator B that bonds to a binder ingredient was obtained.

An optical recording medium of Example 9 was prepared in the same manner as Example 1, except that 1.2% by mass of the photopolymerization initiator of Specific Compound 1 was changed into 1.2% by mass of the Photopolymerization Initiator B, then the sensitivity and the multiplicity thereof was evaluated. The results are shown in Table 1.

### Example 10

An optical recording medium of Example 10 was prepared in the same manner as Example 1, except that 1.2% by mass of the photopolymerization initiator of Specific Compound 1 was changed into 1.2% by mass of a photopolymerization initiator of Specific Compound 16, then the sensitivity and the multiplicity thereof was evaluated. The results are shown in Table 1.

### Example 11

An optical recording medium of Example 11 was prepared in the same manner as Example 1, except that the precursor of the optical recording composition of Example 1 was changed into the precursor shown below, then the sensitivity and the multiplicity thereof was evaluated. The results are shown in Table 1.

| | |
|---|---|
| Biscyclohexyl methanediisocyanate | 31.50% |
| Polypropyleneoxide triol¹⁾ | 61.20% |
| Tetramethylene glycol | 2.50% |
| 2,4,6-tribromophenyl acrylate | 3.10% |
| Photopolymerization Initiator²⁾ | 0.69% |
| Dibutyltindilaurate | 1.01% |

¹⁾molecular weight: 1000
²⁾Specific Compound 13

### Comparative Example 1

An optical recording medium of Comparative Example 1 was prepared in the same manner as Example 1, except that 1.2% by mass of the photopolymerization initiator of Specific Compound 1 was changed into 1.2% by mass of 2,2′-bis(o-chlorophenyl)-4,4′,5,5′-tetraphenyl-1,1′-bisimidazole, then the sensitivity and the multiplicity thereof was evaluated and the structure of the binder prior to the photopolymerization reaction was analyzed. The results are shown in Table 1.

### Comparative Example 2

An optical recording medium of Comparative Example 2 was prepared in the same manner as Example 1, except that 1.2% by mass of the photopolymerization initiator of Specific Compound 1 was changed into 1.2% by mass of 5-(2-(4-methoxycarbonyl-methyloxy-phenyl)ethenyl)-2-trichloromethyl-1,3,4-oxadiazole, then the sensitivity and the multiplicity thereof was evaluated and the structure of the binder prior to the photopolymerization reaction was analyzed. The results are shown in Table 1.

TABLE 1

| | | | Site of | |
|---|---|---|---|---|
| | | | Initiating | Three- |
| | | | Photo- | dimensional |
| | Recording | | polymerization | Cross-linked |
| | Sensitivity | Multiplicity | Reaction | Body |
| Ex. 1 | 150 mJ/cm² | 169 | Exist | Exist |
| Ex. 2 | 150 mJ/cm² | 169 | Exist | Exist |
| Ex. 3 | 130 mJ/cm² | 169 | Exist | Exist |
| Ex. 4 | 150 mJ/cm² | 169 | Exist | Exist |
| Ex. 5 | 140 mJ/cm² | 169 | Exist | Exist |
| Ex. 6 | 150 mJ/cm² | 100 | Exist | Exist |
| Ex. 7 | 200 mJ/cm² | 120 | Exist | Exist |
| Ex. 8 | 200 mJ/cm² | 130 | Exist | Exist |
| Ex. 9 | 150 mJ/cm² | 130 | Exist | non |
| Ex. 10 | 100 mJ/cm² | 169 | Exist | Exist |
| Ex. 11 | 80 mJ/cm² | 169 | Exist | Exist |
| Com. Ex. 1 | 150 mJ/cm² | 30 | non | Exist |
| Com. Ex. 2 | 150 mJ/cm² | 40 | non | Exist |

The results of Table 1 demonstrate that the optical recording media of Examples 1 to 11 exhibit superior properties in recording sensitivity and multiplicity, and the optical recording media of Comparative Examples 1 and 2 exhibit insufficient multiplicity.

The hologram recording composition according to the present invention may bring about high-sensitive hologram recording media adapted to multiple recording, which can be utilized as photosensitive materials adapted to multiple recording of interference images formed from an informing light and a reference light.

The optical recording media according to the present invention may be utilized as various optical recording media of hologram-type, which can record interference images formed from an informing light and a reference light with higher multiplicity.

The present invention may solve various problems in the art, that is, the present invention can provide optical recording compositions that bring about optical recording media capable of multiple-recording interference images formed by an informing light and a reference light with higher sensitivity, the methods for producing the same, and optical recording methods and optical recording apparatuses that utilize the optical recording media. The present invention can also be applied to mono-type optical recording in addition to multiple recording.

What is claimed is:

1. An optical recording composition, comprising a binder and a polymerizable monomer,
wherein the binder has a site to initiate a photopolymerization reaction.

2. The optical recording composition according to claim 1, wherein the binder having a site to initiate a photopolymerization reaction is a reaction product by reaction of a binder precursor with a photopolymerization initiator, and the amount of the photopolymerization initiator is 0.3 part by mass to 6 parts by mass per 100 parts by mass of solid content of the optical recording composition.

3. The optical recording composition according to claim 1, wherein the site to initiate a photopolymerization reaction comprises at least one of 2-trichloromethyl-1,3,4-oxadiazole skeleton, 2,4-bis(trichloromethyl)-1,3,5-triazine skeleton, bisimidazole skeleton, titanocene skeleton, oxime skeleton and benzylketal skeleton.

4. The optical recording composition according to claim 1, wherein the binder having a site to initiate a photopolymerization reaction represents a three-dimensional crosslinked body.

5. The optical recording composition according to claim 1, further comprising a photopolymerization initiator non-bonding to the binder.

6. The optical recording composition according to claim 1, further comprising a binder having no site to initiate a photopolymerization reaction.

7. The optical recording composition according to claim 2, wherein a catalyst is utilized for reacting the binder precursor with the photopolymerization initiator.

8. The optical recording composition according to claim 7, wherein the catalyst is dibutyltindilaurate.

9. The optical recording composition according to claim 1, wherein the polymerizable monomer is one of radical polymerizable monomers and cationic polymerizable monomers.

10. The optical recording composition according to claim 2, further comprising a hydrogen-donating compound of 2-mercaptobenzoxazole.

11. An optical recording medium, comprising a recording layer,
wherein the recording layer comprises the optical recording composition according to claim 1.

12. The optical recording medium according to claim 11, comprising a first substrate, a recording layer, a filter layer and a second substrate in this order.

13. The optical recording medium according to claim 11, wherein the filter layer transmits a first light and reflects a second light.

14. A method for producing an optical recording medium, comprising at least forming a recording layer,
wherein the recording layer comprises the optical recording composition according to claim 1.

15. The method for producing an optical recording medium according to claim 14, comprising:
providing a spacer on one of a first substrate and a second substrate,
applying the optical recording composition on the substrate to which the spacer being provided, and
adhering the substrate having no spacer to the optical recording composition as well as another substrate.

16. An optical recording method comprising:
irradiating an informing light and a reference light having mutual coherence onto an optical recording medium,
forming an interference image from the informing light and the reference light, and
recording the interference image on the optical recording medium,
wherein the optical recording composition comprises a binder and a polymerizable monomer, the binder has a site to initiate a photopolymerization reaction.

17. The optical recording method according to claim 16, wherein irradiating the informing light and the reference light in a manner that the optical axis of the informing light is coaxial with the optical axis of the reference light, and recording the interference image formed from the informing light and the reference light on the optical recording medium.

18. An optical recording apparatus,
wherein an informing light and a reference light having mutual coherence is recorded onto an optical recording medium,
an interference image is formed from the informing light and the reference light, and
the interference image is on the optical recording medium,
wherein the optical recording composition comprises a binder and a polymerizable monomer, the binder has a site to initiate a photopolymerization reaction.
